(19) United States
(12) Patent Application Publication
(10) Pub. No.: US 2010/0010172 A1
(43) Pub. Date: Jan. 14, 2010

(54) IMPACT MODIFIER COMPOSITION FOR TRANSPARENT THERMOPLASTICS

(75) Inventors: Sheng Hong, Berwyn, PA (US); Xianfeng Shen, King of Prussia, PA (US); Charles C. Zhou, Laurel, MD (US); Claude C. Granel, Paris (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/302,175

(22) PCT Filed: May 11, 2007
(86) PCT No.: PCT/US07/68750

§ 371 Date: Sep. 18, 2009

Related U.S. Application Data
(60) Provisional application No. 60/808,279, filed on May 25, 2006.

(51) Int. Cl. C08L 53/00; C08L 53/02

(52) U.S. Cl. 525/92 E; 525/92 F; 525/94

(57) ABSTRACT

The present invention relates to a toughened transparent thermoplastic composite of a transparent thermoplastic and a block copolymer having a block of a random copolymer and an elastomeric block. One preferred embodiment is a polycarbonate that is modified with a block copolymer having a methyl methacrylate (MMA) and naphthyl methacrylate or a substituted naphthyl methacrylate block and an elastomeric block. This block copolymer has excellent miscibility with polycarbonate resin, even at elevated temperature, producing transparent polycarbonate blends. The blend can provide a toughened strength polycarbonate while maintaining its excellent optical properties.

### FIELD OF THE INVENTION

The present invention relates to a toughened transparent thermoplastic composite of a transparent thermoplastic and a block copolymer having a block of a random copolymer and an elastomeric block. One preferred embodiment is a polycarbonate that is modified with a block copolymer having a methyl methacrylate (MMA) and naphthyl methacrylate or a substituted naphthyl methacrylate block and an elastomeric block. This block copolymer forms a microphase separated morphology in polycarbonate resin, even at elevated temperature, producing transparent polycarbonate blends. The blend can provide a toughened strength polycarbonate while maintaining its excellent optical properties.

### BACKGROUND OF THE INVENTION

Polycarbonate (PC) resin has good mechanical and thermal properties such as excellent resistance to impact, stiffness, transparency and dimensional stability at relatively high temperatures. These properties make polycarbonate useful in a variety of applications including glazing containers, glass lenses and medical devices.

Although polycarbonate is inherently tougher than many other thermoplastics, it still has poor low temperature impact strength, poor notch sensitivity, poor impact toughness under plane-strain conditions, and poor performance under fatigue conditions.

Elastomers, such as acrylic or butadiene based core shell modifier, are traditionally used for toughening polycarbonate. Although those modifiers are effective in terms of improving toughness, the molded articles are always opaque due to refractive index mismatch between the modifier and the matrix and the large particle size of the modifier (>100 nm) that causes strong diffusive scattering. Block copolymers, such as poly(styrene)-b-polybutadiene-b-polystyrene (SBS), have been available in the market for a long time. However, SBS type block copolymers, when used as an additive, can only maintain transparency in limited number of host matrices, specifically polystyrene and polyphenylene ether. In deed, in all except very special cases, a block copolymer, if blended with another polymer, results in opacity due to macrophase separation instead of microphase separation.

Most impact modifiers known in the art for polycarbonate produce a product that is opaque or translucent, such as found in U.S. Pat. No. 4,997,833 which describes an elastomeric graft copolymer for improving the impact strength of PC, consisting of a grafted aromatic(meth)acrylate/methyl methacrylate random copolymer onto a EPDM polymer. A means is desired to improve the toughness of polycarbonate while at the same time maintaining its excellent transparency.

U.S. Pat. No. 4,319,003 describes an impact resistant transparent block copolymer of low molecular weight polymethyl methacrylate and polycarbonate.

U.S. Pat. No. 5,284,916 describes a block copolymer of a polyaromatic(alkyl)methacrylate (PAAM) and an elastomer for providing impact modification of a transparent polycarbonate. The reference describes the PAAM portion of the block as being completely miscible with PC, with the elastomer being microphase separated with a dispersed size less than the wavelength of light, resulting in a transparent and impact improved PC. The block copolymer is formed by anionic polymerization at −78° C. The block sizes of 12,000-85,000 for the PAAM block and 30,000 to 150,000 for the elastomeric block are relatively small. While the '916 reference claims any level of the block copolymer impact modifier in the PC, it has been shown that a relatively transparent blend can be obtained only at very low (5% or less) loading levels of the impact modifier—resulting in only minor improvement in the impact strength.

Surprisingly it has been found that a stable, homogeneous, impact-modified transparent polycarbonate can be produced using a block copolymer of a methyl methacrylate/naphthyl methacrylate random copolymer block with an elastomeric block. The composition can be used at high loading levels in polycarbonate without a noticeable effect on the transparency.

### SUMMARY OF THE INVENTION

The invention relates to a toughened transparent thermoplastic composite comprising:

a) 50 to 99 weight percent of a transparent thermoplastic matrix B; and

b) 1 to 50 weight percent of a block copolymer comprising:
1) 5-98 weight percent of a random copolymer comprising copolymerizable ethylenically unsaturated monomers α and β; and
2) an elastomeric block;
   wherein said copolymerizable ethylenically unsaturated monomers α and β, are selected so that the Flory-Huggins Pair-Wise Interaction Parameter χ between monomer unit α and monomer unit β (χ_{αβ}) is larger than that of unit α and matrix B (χ_{αB}) and that of unit β and matrix B (χ_{βB}), and wherein said thermoplastic composite is transparent.

The invention especially relates to a transparent polycarbonate with a substituted phenyl methacrylate, and in particular a naphthyl or substituted naphthyl methacrylate.

The invention also relates to articles made from the toughened thermoplastic

### BRIEF SUMMARY OF THE DRAWINGS

FIG. 1. Shows Blends of Example 4 with PC at different percentages of block copolymer impact modifier loading.

FIG. 2. Is an Atom Force Micrograph of a PC/block copolymer blend at 40% loading of block copolymer.

### DETAILED DESCRIPTION OF THE INVENTION

The present invention relates to a toughened transparent thermoplastic composite of a transparent thermoplastic matrix (B) and a block copolymer A. Block copolymer A contains at least two blocks wherein one of the blocks is a random copolymer of monomers α and β, wherein the Flory-Huggins Pair-Wise Interaction Parameter χ between unit α and unit β (χ_{αβ}) is larger than that of unit α and matrix B (χ_{αB}) and that of unit β and matrix B (χ_{βB}).

χ_{αβ}>χ_{αB} and χ_{αβ}>χ_{βB}

Parameter χ can be measured via typical methods as discussed in the field of polymer thermodynamics such as the critical molecular weight method, scattering experiments, melting point depression, heat of solution, and inverse gas phase chromatography (IGC), etc.

It is also anticipated that the random copolymer may contain more than two monomers, and the same relationship would exist extended to three or more monomers.

The use of block copolymer A in matrix B maintains the optical properties of matrix B.

While not being bound by any particular theory, it was observed that a well-defined separate microphase morphology formed in the micrographs of the Examples in polycarbonate. It is believed that the microphase separation was brought about by the thermodynamic interaction among methyl methacrylate (MMA), 2-naphthyl methacrylate (2-NpMA) and polycarbonate (PC). Specifically, the Flory-Huggins Pair-Wise Interaction Parameter was measured, which characterizes the pair-wise interaction among those there units, via the critical molecular weight method, subject to experimental error, and obtained: χ_{MMA/PC}=0.017, χ_{NpMA/PC}=0.68, and χ_{MMA/NpMA}=0.88 (at 280° C.) (unit: dimensionless). Accordingly, it is found that to maintain the transparency of the matrix yet still to introduce discrete elastomer domains, it is preferred that χ_{αβ}>χ_{αB} and χ_{αβ}>χ_{βB}. Under such conditions, a block copolymer containing a random copolymer block can preserve the optical property of the matrix much better than that of a block copolymer containing only homopolymers. A “random copolymer”, as used in this invention this invention, is defined as a copolymerization of two or more comonomers where the comonomers are added together (batchwise) rather than sequential (stepwise) as for typical block copolymer preparation. The term “random” does not mean the copolymer is statistically random as opposed to blocky or alternating as defined by copolymerization statistical model.

One in the art can apply the principle of the invention to many different matrix thermoplastics using a variety of block copolymers that contain an elastomeric block and a random block in which monomers and thermoplastic matrix have the relationship described above. Some suitable transparent thermoplastic matrix materials to which the principle of the invention can be applied include, but are not limited to: acrylonitrile/butadiene/styrene terpolymer, acrylonitrile/styrene/acrylate copolymer, polycarbonate, polyester, polyethylene terephthalate glycol, methyl methacrylate/butadiene/styrene copolymer, high impact polystyrene, acrylonitrile/acrylate copolymer, polystyrene, styrene/acrylonitrile copolymer, methylmethacrylate/styrene copolymer, an acrylonitrile/methyl methacrylate copolymer, polyolefins, imidized acrylic polymer, or an acrylic polymer.

While many different thermoplastics, elastomeric blocks and random copolymer blocks may be used, the remainder of the disclosure will focus on a polycarbonate matrix and a block copolymer having an elastomeric block and a random copolymer having methyl methacrylate and substituted aryl(meth)acrylate monomer units.

The random copolymer block has the structural formula:

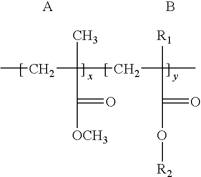

where x and y are integers calculated to resulted in a content of PMMA in the copolymer in the range of 5 to 98 weight percent and where R₁ denotes —CH₃ or H and R₂ is an aryl group or substituted aryl group including a phenyl and/or substituted phenyl group and a naphthyl and/or substituted naphthyl group.

The substituted aryl(meth)acrylate is present in the random copolymer block at from 2 to 95 weight percent, and preferably from 10 to 70 weight percent, and the corresponding level of methyl methacrylate being from 5 to 98 and preferably from 30 to 90 weight percent. While a 50/50 weight ratio of monomers provides a theoretically best ratio, from an economic standpoint, the methyl methacrylate monomer is less expensive, and therefore a random copolymer having 25 to 45 weight percent of the substituted phenyl (meth)acrylate is preferred. The substituted phenyl (meth)acrylate includes naphthyl and substituted naphthyl (meth)acrylate groups, and mixtures thereof. The (meth)acrylate designation is meant to include both the acrylate, the methacrylate, and mixtures thereof. Examples of substituted naphthyl groups useful in the invention include, but are not limited to, alkyl and aryl side groups, and functional groups such as carboxyls, OH, and halides

In addition to the methyl methacrylate and napthyl (meth)acrylate, up to 40 weight percent of the copolymer block can be one or more other ethylenically unsaturated monomer units that are copolymerizable with the methyl methacrylate (MMA) and napthyl (meth)acrylate (NpMA). The term “copolymer” as used herein is intended to include both polymers made from two monomers, as well as polymers containing three or more different monomers. Preferred termonomers include acrylates, methacrylates and styrenic, including but not limited to linear, or branched C₁₋₁₂ alkyl and aryl (meth)acrylates, styrene and alpha-methyl styrene.

While not being bound by any particular theory it is believed that nanostructurization occurs due to the elastomeric block and polycarbonate being mutually repulsive, whereas the random copolymer block is compatible or miscible with the polycarbonate. As a result, the random copolymer is more miscible in the polycarbonate matrix than a homopolymer of either MMA or NpMA would be.

The copolymer block has a weight-averaged molecular weight in the range of 5,000 g/mol to 4,000,000 g/mol, and preferably 50,000 to 2,000,000 g/mol.

The elastomeric blocks generally have a Tg of less than 20° C., and preferably less than 0° C., and most preferably less than −20° C. Preferred soft blocks include polymers and copolymers of alkyl acrylates, dienes such as polybutadiene and polyisoprene, styrenics, polyethylene, polysiloxane, and mixtures thereof. Preferably the soft block is composed mainly of acrylate ester units. Acrylate ester units useful in forming the soft block include, but are not limited to, methyl acrylate, ethyl acrylate, n-propyl acrylate, isopropyl acrylate, n-butyl acrylate, isobutyl acrylate, sec-butyl acrylate, tert-butyl acrylate, amyl acrylate, isoamyl acrylate, n-hexyl acrylate, cycloheyl acrylate, 2-ethylhexyl acrylate, pentadecyl acrylate, dodecyl acrylate, isobornyl acrylate, phenyl acrylate, benzyl acrylate, phnoxyethyl acrylate, 2-hydroxyethyl acrylate and 2-methoxyethyl acrylate. Preferably the acrylate ester units are chosen from methyl acrylate, ethyl acrylate, n-butyl acrylate, 2-ethylhexyl acrylate and octyl acrylate. Useful dienes include, but are not limited to isoprene and butadiene.

The block copolymer can be produced by means known in the art for producing a controlled architecture structure. Block copolymers useful in the invention can include di-block, triblock (both A-B-A and B-A-B types), star block copolymers and A-B-A-B- alternating block copolymers.

In principle, any living or controlled polymerization technique can be utilized to make the block copolymer. However, for the practicality of controlling acrylics, the block copolymers of the present invention are preferably formed by controlled radical polymerization (CRP). These processes generally combine a typical free-radical initiator with a compound to control the polymerization process and produce polymers of a specific composition, and having a controlled molecular weight and narrow molecular weight range. These free-radical initiators used may be those known in the art, including, but not limited to peroxy compounds, peroxides, hydroperoxides and azo compounds which decompose thermally to provide free radicals. In one embodiment the initiator may also contain the control agent.

Examples of controlled radical polymerization techniques will be evident to those skilled in the art, and include, but are not limited to, atom transfer radical polymerization (ATRP), reversible addition fragmentation chain transfer polymerization (RAFT), nitroxide-mediated polymerization (NMP), boron-mediated polymerization, and catalytic chain transfer polymerization (CCT). Descriptions and comparisons of these types of polymerizations are described in the ACS Symposium Series 768 entitled Controlled/Living Radical Polymerization: Progress in ATRP, NMP, and RAFT, edited by Krzystof Matyjaszewski, American Chemical Society, Washington, D.C., 2000.

One preferred method of controlled radical polymerization is nitroxide-mediated CRP. Nitroxide-mediated polymerization can occur in bulk, solvent, and aqueous polymerization, can be used in existing equipment at reaction times and temperature similar to other free radical polymerizations. One advantage of nitroxide-mediated CRP is that the nitroxide is generally innocuous and can remain in the reaction mix, while other CRP techniques require the removal of the control compounds from the final polymer.

The mechanism for this control may be represented diagrammatically as below:

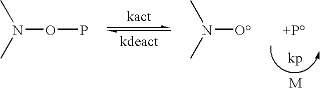

with M representing a polymerizable monomer and P representing the growing polymer chain.

The key to the control is associated with the constants K_{deact}, k_{act} and kₚ (T. Fukuda and A. Goto, Macromolecules 1999, 32, pages 618 to 623). If the ratio k_{deact}/k_{act} is too high, the polymerization is blocked, whereas when the ratio kₚ/k_{deact} is too high or when the ratio k_{deac}/k_{act} is too low though, the polymerization is uncontrolled.

It has been found (P. Tordo et al., Polym. Prep. 1997, 38, pages 729 and 730; and C. J. Hawker et al., Polym. mater. Sci. Eng., 1999, 80, pages 90 and 91) that β-substituted alkoxyamines make it possible to initiate and control efficiently the polymerization of several types of monomers, whereas TEMPO-based alkoxyamines [such as (2′,2′,6′,6′-tetramethyl-1′-piperidyloxy-)methylbenzene mentioned in Macromolecules 1996, 29, pages 5245-5254] control only the polymerizations of styrene and styrenic derivatives. TEMPO and TEMPO-based alkoxyamines are not suited to the controlled polymerization of acrylics.

The nitroxide-mediated CRP process is described in, U.S. Pat. No. 6,255,448, US 2002/0040117 and WO 00/71501, incorporated herein by reference. The above-stated patents describe the nitroxide-mediated polymerization by a variety of processes. Each of these processes can be used to synthesize polymers described in the present invention.

In one process the free radical polymerization or copolymerization is carried-out under the usual conditions for the monomer or monomers under consideration, as known to those skilled in the art, with the difference being that a β-substituted stable free radical is added to the mixture. Depending on the monomer or monomers which it is desired to polymerize, it may be necessary to introduce a traditional free radical initiator into the polymerization mixture as will be evident to those skilled in the art.

Another process describes the polymerization of the monomer or monomers under consideration using a alkoxyamine obtained from β-substituted nitroxides of formula (I) wherein A represents a mono- or polyvalent structure and R_{L} represents a mole weight of more than 15 and is a monovalent radical, and n≧1.

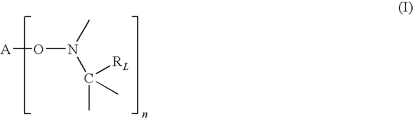

Another process describes the formation of polyvalent alkoxyamines of formula (I), based on the reaction of multifunctional monomers, such as, but not limited to, acrylate monomers and alkoxyamines at controlled temperatures. The multifunctional alkoxyamines of formula (I), wherein n≧2, may then be utilized to synthesize linear star and branched polymeric and copolymeric materials from the monomer or monomers under consideration.

Another process describes the preparation of multimodal polymers where at least one of the monomers under consideration is subjected to free radical polymerization in the presence of several alkoxyamines comprising the sequence of formula (I), wherein n is a non-zero integer and the alkoxyamines exhibit different values of n.

The alkoxyamines and nitroxyls (which nitroxyls may also be prepared by known methods separately from the corresponding alkoxyamine) as described above are well known in the art. Their synthesis is described for example in U.S. Pat. No. 6,255,448 and WO 00/40526.

In general, the preferred molecular weight of the block size copolymer is from is 30,000 to 500,000 g/mol, preferably from 50,000 to 200,000 g/mol. The molecular weight distribution, as measured by M_{w}/Mₙ or polydispersity is generally less than 4.0, and preferably below 3.0.

The ratio of the copolymer acrylic block to the elastomer blocks is from 10-90/90-10 percent by weight. Preferably from 30-70/70-30.

The term “polycarbonate (PC)” denotes a polyester of carbonic acid, that is to say a polymer obtained by the reaction of at least one carbonic acid derivative with at least one aromatic or aliphatic diol. The preferred aromatic diol is bisphenol A, which reacts with phosgene or else, by transesterification, with ethyl carbonate. It can be homopolycarbonate or copolycarbonate based on a bisphenol of formula HO-Z-OH for which Z denotes a divalent organic radical which has from 6 to 30 carbon atoms and which comprises one or more aromatic group(s). As examples, the diphenol can be:
dihydroxybiphenyls,
bis(hydroxyphenyl)alkanes,
bis(hydroxyphenyl)cycloalkanes,
indanebisphenols,
bis(hydroxyphenyl)ethers,
bis(hydroxyphenyl) ketones,
bis(hydroxyphenyl) sulphones,
bis(hydroxyphenyl) sulphoxides,
α,α′-bis(hydroxyphenyl)diisopropylbenzenes.
   It can also relate to derivatives of these compounds obtained by alkylation or halogenation of the aromatic ring. Mention will more particularly be made, among the compounds of formula HO-Z-OH, of the following compounds:
hydroquinone,
resorcinol,
4,4′-dihydroxybiphenyl,
bis(4-hydroxyphenyl) sulphone,
bis(3,5-dimethyl-4-hydroxyphenyl)methane,
bis(3,5-dimethyl-4-hydroxyphenyl) sulphone,
1,1-bis(3,5-dimethyl-4-hydroxyphenyl)-para/meta-isopropylbenzene,
1,1-bis(4-hydroxyphenyl)-1-phenylethane,
1,1-bis(3,5-dimethyl-4-hydroxyphenyl)cyclohexane,
1,1-bis(4-hydroxyphenyl)-3-methylcyclohexane,
1,1-bis(4-hydroxyphenyl)-3,3-dimethylcyclohexane,
1,1-bis(4-hydroxyphenyl)-4-methylcyclohexane,
1,1-bis(4-hydroxyphenyl)cyclohexane,
1,1-bis(4-hydroxyphenyl)-3,3,5-trimethylcyclohexane,
2,2-bis(3,5-dichloro-4-hydroxyphenyl)propane,
2,2-bis(3-methyl-4-hydroxyphenyl)propane,
2,2-bis(3,5-dimethyl-4-hydroxyphenyl)propane,
2,2-bis(4-hydroxyphenyl)propane (or bisphenol A),
2,2-bis(3-chloro-4-hydroxyphenyl)propane,
2,2-bis(3,5-dibromo-4-hydroxyphenyl)propane,
2,4-bis(4-hydroxyphenyl)-2-methylbutane,
2,4-bis(3,5-dimethyl-4-hydroxyphenyl)-2-methylbutane,
α,α′-bis(4-hydroxyphenyl)-o-diisopropylbenzene,
α,α′-bis(4-hydroxyphenyl)-m-diisopropylbenzene (or bisphenol M).

The preferred polycarbonates are the homopolycarbonates based on bisphenol A or 1,1-bis(4-hydroxyphenyl)-3,3,5-trimethylcyclohexane and the copolycarbonates based on bisphenol A and 1,1-bis(4-hydroxyphenyl)-3,3,5-trimethylcyclohexane. The polycarbonate generally has a weight average molecular weight of 10,000 to 200,000.

The block copolymer impact modifier of the invention is blended with polycarbonate at from 50 to 99, preferably from 60 to 95 and most preferably 75 to 90 weight percent of polycarbonate with 1 to 50, preferably from 5 to 40, and most preferably 10 to 25 weight percent of the block copolymer.

In addition to the copolymer and polycarbonate, other common additives may also be blended into the composition. The additives could include, but are not limited to pigments, dyes, plasticizers, antioxidants, heat stabilizers, UV stabilizers, processing additives or lubricants, inorganic particles, cross-linked organic particles, and impact modifiers. In one embodiment, the lock copolymer is used as a dried pellet or powder and is blended with polycarbonate pellets along with any other additives to form a polycarbonate composite through melt compounding and extrusion.

The polycarbonate/block copolymer composite of the invention has excellent miscibility with polycarbonate resin, even at elevated temperature, producing transparent polycarbonate blends. The blend provides an improved impact strength polycarbonate while maintaining its excellent optical properties.

While not being bound by any particular theory, it is believed that the transparency of polycarbonate is maintained due to the block copolymer self-assembly into nanoscale domains with a dispersed size less than the wavelength of light.

The polycarbonate/block copolymer blend or composite of the invention stays miscible up to at least 320° C., resulting in a clear composition, even under high temperature processing conditions.

The introduction of discrete elastomeric domains has the ability to improve the fracture toughness of the polycarbonate resin, such as the notch sensitivity, thickness sensitivity and low temperature performance.

Additionally, the block copolymer provides an improved scratch resistance to the polycarbonate composite.

The polycarbonate/block copolymer blend or composite of the invention can be used to form articles, and especially transparent articles by means known in the art, including, but not limited to melt extrusion, injection molding, thermoforming, blown films, fiber spinning, and blow molding.

Some of the useful articles that can be formed from the blend of the invention include, but are not limited to transparent films, optical discs such as DVDs and CDs, sheet, rods, pellets, films for use as an outer layer in a flat panel display or LED, membrane switches, decals or transfer films, instrument panels, smart cards, glazing containers, glass lenses and medical devices In one embodiment, the polycarbonate/block copolymer blend is melt compounded by extrusion, then injection molded directly into articles, or into sheets, films, profiles, or pellets that can be further processed into articles.

### EXAMPLES

### Example 1

### Synthesis of the Block Copolymers by CRP

The reaction was carried out in two steps. First, the mixture of alkoxyamine as initiator and butyl acrylate as monomer was degassed before the temperature was raised to reaction temperature 120° C. The reactions were carried out at low pressure of nitrogen under agitation, and monitored by sampling. Once the desired conversion was obtained, the reaction was cooled down quickly. The residual monomer was stripped off under vacuum. Second, benzyl methacrylate (BzMA) or phenyl methacrylate (PhMA) or mixtures of the above monomers and MMA were dissolved in toluene and added to the reactor with the PBA 1^{st} block. After degas with nitrogen under stirring, the temperature is raised to 120° C. The reaction was stopped until desired conversion was reached. The residual monomers and toluene was removed by precipitating the mixture into cold stirring methanol.

### Example 2

### Compounding Polycarbonate with the Block Copolymers

The block copolymers were compounded with GE LEXAN 1110 polycarbonate at 250° C. followed by injection molding with Nozzle temperature at 270° C. and mold temperature at 110° C.

The compositions and the light transmission measured by a Gardner Hazemeter of the compounded samples are summarized in Table 1.

### Example 3

### Synthesis of the Block Copolymers by CRP

The reaction was carried out in two steps. First, the mixture of alkoxyamine as initiator and butyl acrylate as monomer was degassed before the temperature was raised to reaction temperature 120° C. The reactions were carried out at low pressure of nitrogen under agitation, and monitored by sampling. Once the desired conversion was obtained, the reaction was cooled down quickly. The residual monomer was stripped off under vacuum. Second, 2-naphthyl methacrylate (NpMA) and methyl methacrylate (MMA) was dissolved in toluene and added to the reactor with the PBA 1^{st} block. After degas with nitrogen under stirring, the temperature is raised to 120° C. The reaction was stopped until desired conversion was reached. The residual monomers and toluene was removed by precipitating the mixture into cold stirring methanol.

### Example 4

### Compounding Polycarbonate with the Block Copolymer of Example 3

The block copolymer of Example 3 was compounded with GE LEXAN 1110 polycarbonate at 250° C. followed by injection molding with Nozzle temperature at 270° C. and mold temperature at 110° C.

The compositions and the light transmission measured from Gardner Hazemeter of the compound samples are summarized in Table 1.

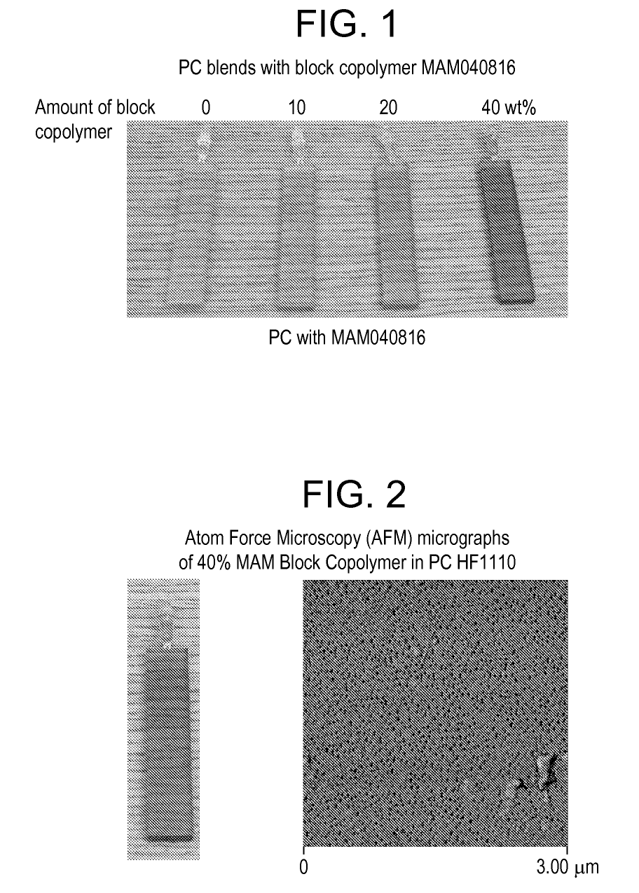

The appearances of these compound bars are given in FIG. 1.

TABLE 1
PC compounds with block copolymers

| | | | Light Transmission |
|---|---|---|---|
| | | | Percentage |
| Sample | Block Copolymer | Additive wt % | (Normalized) |
| 1 (comp) | / | 0 | 100% |
| 2 | M1-BA-M1 | 0 | 55% |
| 3 | M1-BA-M1 | 10 | 24% |
| 4 | M1-BA-M1 | 20 | 10% |
| 5 | BzMA-BA-BzMA | 5 | 11% |
| 6 | BzMA-BA-BzMA | 10 | 4% |
| 7 | BzMA-BA-BzMA | 20 | 1% |
| 8 | M2-BA-M2 | 5 | 79% |
| 9 | M2-BA-M2 | 10 | 61% |
| 10 | M2-BA-M2 | 20 | 37% |
| 11 | PhMA-BA-PhMA | 5 | 61% |
| 12 | PhMA-BA-PhMA | 10 | 50% |
| 13 | PhMA-BA-PhMA | 20 | 22% |
| 14 | M3-BA-M3 | 10 | 99% |
| 15 | M3-BA-M3 | 20 | 96% |
| 16 | M3-BA-M3 | 40 | 95% |
| 17 | NpMA-BA-NpMA | 5 | 49% |
| 18 | NpMA-BA-NpMA | 10 | 28% |
| 19 | NpMA-BA-NpMA | 20 | 15% |

M1 denotes poly(MMA-co-40 wt % BzMA)
M2 denotes poly(MMA-co-40 wt % PhMA)
M3 denotes poly(MMA-co-40 wt % NpMA)

### Example 5

### Atom Force Microscopy (AFM) Characterization of the Compounds

A small piece of the compound of Example 4 was subjected to AFM characterization. AFM micrograph of this sample clearly indicates the formation of microphase-separated morphology, as illustrated in FIG. 2. The uniformly dispersed nano-sized black dots indicate that the poly(butyl acrylate) rubbery domain was microphase separated among the PC matrix.

What is claimed is:

1. A toughened transparent thermoplastic composite comprising:
a) 50 to 99 weight percent of a transparent thermoplastic matrix B; and
b) 1 to 50 weight percent of a block copolymer comprising:
a. 5-98 weight percent of a random copolymer comprising copolymerizable ethylenically unsaturated monomers α and β; and
b. an elastomeric block;
wherein said copolymerizable ethylenically unsaturated monomers α and β, are selected so that the Flory-Huggins Pair-Wise Interaction Parameter χ between monomer unit α and monomer unit β (χ_{αβ}) is larger than that of unit α and matrix B (χ_{αB}) and that of unit β and matrix B (χ_{βB}), and wherein said thermoplastic composite is transparent.

2. The thermoplastic composite of claim 1 wherein said transparent thermoplastic matrix is selected from the group consisting of acrylonitrile/butadiene/styrene terpolymer, acrylonitrile/styrene/acrylate copolymer, polycarbonate, polyester, polyethylene terephthalate glycol, methyl methacrylate/butadiene/styrene copolymer, high impact polystyrene, acrylonitrile/acrylate copolymer, polystyrene, styrene/acrylonitrile copolymer, methylmethacrylate/styrene copolymer, an acrylonitrile/methyl methacrylate copolymer, polyolefins, imidized acrylic polymer, and an acrylic polymer.

3. The thermoplastic composite of claim 1 wherein said elastomeric block has a Tg of less than 20° C.

4. The thermoplastic composite of claim 1 wherein said elastomeric block has a Tg of less than 0° C.

5. The thermoplastic composite of claim 1 wherein said elastomeric block has a Tg of less than −20° C.

6. The thermoplastic composite of claim 1 wherein said elastomeric block is selected from the group consisting of C₂₋₈ alkyl acrylates, polybutadiene, polyisoprene, styrenics, polyethylene, polysiloxane, and mixtures thereof.

7. The thermoplastic composite of claim 1 further comprising one or more additives selected from the group consisting of pigments, dyes, plasticizers, antioxidants, heat stabilizers, UV stabilizers, processing additives or lubricants, inorganic particles, cross-linked organic particles, and impact modifiers.

8. The transparent thermoplastic composite of claim 1 comprising:
a) 50 to 98 weight percent of polycarbonate; and
b) 2-50 weight percent of a block copolymer comprising:
1) a a random copolymer block comprising:
i) 5-98 weight percent of methyl methacrylate units; and
ii) 2 to 95 weight percent of a substituted phenyl(meth)acrylate units, and
2) an elastomeric block.

9. The transparent thermoplastic of claim 8, wherein said substituted phenyl(meth)acrylate units are naphthyl methacrylate units and/or substituted naphthyl methacrylate units.

10. The thermoplastic composite of claim 8 comprising:
a) 60 to 95 weight percent of polycarbonate; and
b) 5 to 40 weight percent of said block copolymer.

11. The thermoplastic composite of claim 8 wherein said random copolymer block comprises:
1) 30-90 weight percent of methyl methacrylate units; and
2) 10 to 70 weight percent of naphthyl methacrylate units and/or substituted naphtyl methacrylate units.

12. The thermoplastic composite of claim 8 wherein said random copolymer further comprises up to 40 weight percent one or more ethylenically unsaturated monomer units copolymerizable with said methyl methacrylate and naphthyl metacrylate monomer units.

13. The thermoplastic composite of claim 8, wherein said ethylenically unsaturated monomer units are one or more monomers selected from the group consisting of acrylates, methacrylates and styrenics.

14. The thermoplastic composite of claim 12, wherein said ethylenically unsaturated monomer units are selected from C₁₋₁₂ alkyl acrylates and C₁₋₁₂ alkyl methacrylates.

15. The thermoplastic composite of claim 8, wherein said block copolymer is formed by a nitroxide-mediated controlled radical polymerization.

16. The thermoplastic composite of claim 1, wherein said block copolymer has a molecular weight from 30,000 to 500,000 g/mol.

17. The thermoplastic composite of claim 1, wherein said block copolymer has a molecular weight from 50,000 to 200,000 g/mol.

18. An article comprising a toughened thermoplastic composite comprising
a. 50 to 98 weight percent of a transparent thermoplastic matrix B; and
b. 2 to 50 weight percent of a block copolymer comprising:
1) 5-98 weight percent of a random copolymer comprising copolymerizable ethylenically unsaturated monomers α and β; and
2) an elastomeric block;
wherein said copolymerizable ethylenically unsaturated monomers α and β, are selected so that the Flory-Huggins Pair-Wise Interaction Parameter χ between monomer unit α and monomer unit β (χ_{αβ}) is larger than that of unit α and matrix B (χ_{αB}) and that of unit β and matrix B (χ_{βB}), and wherein said thermoplastic composite is transparent.

19. The article of claim 18 comprising a transparent film, optical disc such as a DVD or CD, a sheet, rods, pellets, films for use as an outer layer in a flat panel display or LED, membrane switches, decals or transfer films, instrument panels, smart cards, glazing containers, glass lenses or medical devices.
